(19) United States
(12) Patent Application Publication
(10) Pub. No.: US 2024/0099449 A1
(43) Pub. Date: Mar. 28, 2024

(54) LYMPHATIC DRAINAGE DEVICE AND METHODS OF USE

(71) Applicant: CJB GLOBAL IMPORTS, INC., Lakewood, CO (US)

(72) Inventor: Cecily J. Braden, New York, NY (US)

(21) Appl. No.: 18/473,842

(22) Filed: Sep. 25, 2023

Related U.S. Application Data
(60) Provisional application No. 63/409,564, filed on Sep. 23, 2022.

(51) Int. Cl. A46B 3/00

(52) U.S. Cl. CPC A46B 3/00; A46B 2200/102

(57) ABSTRACT

Methods and systems for massage and therapy are provided. In certain embodiments, methods and systems comprising handheld brushes are provided. In some embodiments and applications, brushes are provided that are operable for dry brushing and enhancing the natural transit and drainage of lymphatic fluid are provided. Novel arrangements for brushes and related bristles are provided. Novel case configurations for the brush are also provided.

### CROSS-REFERENCE TO RELATED APPLICATIONS

The present application claims priority to U.S. Provisional Application No. 63/409,564, filed on Sep. 23, 2022, and entitled “LYMPHATIC DRAINAGE DEVICE AND METHODS OF USE,” which is hereby incorporated by reference in the entirety.

### FIELD

Embodiments of the present disclosure relate to methods and systems for therapeutic massage. In some embodiments, methods, system, and devices are provided for massage and manual lymphatic drainage. In certain embodiments, devices are provided that comprise preferred bristle arrangements to assist in manual lymphatic drainage and other massage techniques.

### BACKGROUND

The lymphatic or lymphoid system is an organ system that is a component of the immune system and consists of lymphatic vessels, lymph nodes, lymphatic or lymphoid organs and lymphoid tissues. The system carries lymph fluid through the body and provides an accessory return route to the blood and immune defense.

Manual lymphatic drainage (“MLD”) is a type of massage that encourages the natural drainage of the interstitial fluid, which carries waste products away from the tissues, cleans the fluid then sends it back toward the heart (i.e., lymph via lymph vessels). MLD is a gentle unidirectional massage performed on specific areas of the body to assist with the flow of fluids from the tissue into the lymphatic system to be filtered and redistributed in the body or flushed out via the kidneys.

The lymph system depends on intrinsic contractions of the smooth muscle cells in the walls of the lymph vessels via peristalsis. The natural process can be aided by manual application of force (e.g., external tension) in the form of MLD and specific movements to stimulate lymph flow.

### SUMMARY

While the general concept of MLD is known, there exists a long-felt and unmet need to provide improved methods and systems for MLD. Embodiments of the present disclosure provide improved methods and systems for MLD including, for example, improved drainage and improved ergonomic benefits for the administrator and recipient of MLD.

In some embodiments, a device is provided that comprises a brush operable for use with MLD. While various embodiments of the present disclosure contemplate and provide a brush that is operable for use with MLD, it should be recognized that the brushes and devices of the present disclosure are not limited to use with MLD. For example, massage brushes of the present disclosure and as shown and described herein are useful for various applications including but not limited to MLD. Such applications include, for example, other massage techniques, application of cosmetics, relaxation techniques, and similar intended uses.

Embodiments of the present disclosure contemplate and provide for methods and systems for massage and treatments (for example) wherein the tissue is manipulated and massaged via a brush with bristles. Specific bristle patterns and arrangements are provided to increase the accuracy, effectiveness, and comfort of treatments including, but not limited to, MLD. While various embodiments of the present disclosure are well suited for MLD on the neck, head, and face regions of a human, it will be recognized that no limitation with respect to massage location or technique is provided herewith.

Methods and systems of the present disclosure contemplate the provision and reduction of the transit stretch, as well as a lymphatic pull, whereby the process of the loose connective tissue anchoring filaments are stretched or pulled to release fluid(s) into the initial lymph vessel. This process generally comprises a unidirectional opening of the semilunar valves and occurs naturally at a rate of approximate four to six times per minute. Methods and systems of the present disclosure as shown and described herein are operable to increase this rate and decrease or stimulate transit stretch through manual activations.

In various embodiments, a combination of bristle arrangement and brush handle shape is provided that improves user experience and end results. The bristles combined with the ergonomic base as shown and described herein in various embodiments provides improved MLD, improves the drainage of excess fluids, boosts immunity, relieves chronic pain, and induces a parasympathetic state.

In various embodiments, bristles are provided with a thickness or diameter of approximately 0.1 mm. However, no limitation with respect to bristle thickness is provided herewith. Inventive aspects of the present disclosure are provided that are not specific to or limited to a particular bristle thickness. The bristles are contemplated as comprising a thickness of between approximately 0.01 mm and 5.0 mm. Additionally, while certain embodiments of the present disclosure contemplate the provision of bristles comprising a generally circular cross-section, alternatively shaped bristles are also contemplated. In some embodiments, the bristles comprise polybutylene terephthalate. Various alternative bristle materials are also contemplated.

A first aspect of the present disclosure is directed to a therapeutic massage brush comprising: a handle portion operable to grasped by a user; and a plurality of bristles extending from the handle portion, wherein the plurality of bristles comprises a set of primary bristles and a plurality of protuberances, wherein proximal ends of at least one of the primary bristles and the plurality of protuberances are provided proximal from the handle portion and are provided in a concave arrangement.

The therapeutic massage brush of the first aspect may include, optionally, a plurality of bristles that comprise a second set of bristles grouped together, and wherein each protuberance of the plurality of protuberances is at a proximal end of a particular grouping of bristles of the second set of bristles.

The therapeutic massage brush of the first aspect may include one or more of the previous embodiments and, optionally, wherein the plurality of bristles is coupled to a substrate that is couplable to a handle portion, wherein the substrate includes a plurality of apertures, and wherein each grouping of bristles of the second set of bristles is extended through a particular aperture of the plurality of apertures.

The therapeutic massage brush of the first aspect may include one or more of the previous embodiments and, optionally, wherein the first set of bristles are coupled to a front surface of the substrate, and wherein each grouping of bristles of the second set of bristles is extended through a particular aperture of the plurality of apertures through a rear surface of the substrate prior to the rear surface of the substrate being coupled to the handle portion.

The therapeutic massage brush of the first aspect may include one or more of the previous embodiments and, optionally, wherein the first set of bristles of the plurality of bristles have a first hardness and a first density, and wherein the second set of bristles of the plurality of bristles have a second, different hardness and a second, different density.

The therapeutic massage brush of the first aspect may include one or more of the previous embodiments and, optionally, wherein the first set of bristles of the plurality of bristles have a first length, and wherein the second set of bristles of the plurality of bristles have a second, different length.

The therapeutic massage brush of the first aspect may include one or more of the previous embodiments and, optionally, wherein the first set of bristles of the plurality of bristles have a first color, and wherein the second set of bristles of the plurality of bristles have a second, different color.

The therapeutic massage brush of the first aspect may include one or more of the previous embodiments and, optionally, wherein the handle portion includes a convex distal end and a concave proximal end.

The therapeutic massage brush of the first aspect may include one or more of the previous embodiments and, optionally, wherein the convex distal end of the handle portion is contoured to conform to a first arc and the concave proximal end of the handle portion is contoured to conform to a second different arc.

The therapeutic massage brush of the first aspect may include one or more of the previous embodiments and, optionally, wherein the first arc is a portion of an ellipse and the second arc is a portion of a circle.

The therapeutic massage brush of the first aspect may include one or more of the previous embodiments and, optionally, wherein the handle portion comprises an upper surface, and wherein the plurality of bristles is coupled to and extend from the upper surface.

The therapeutic massage brush of the first aspect may include one or more of the previous embodiments and, optionally, wherein a portion of the upper surface is visible after the plurality of bristles is coupled to the upper surface.

The therapeutic massage brush of the first aspect may include one or more of the previous embodiments and, optionally, wherein the plurality of bristles is surrounded by a portion of the upper surface after the plurality of bristles are coupled to the upper surface.

A second aspect of the present disclosure is directed to a therapeutic massage system, comprising a therapeutic massage brush and a case. The therapeutic massage brush comprises a handle portion operable to grasped by a user; and a plurality of bristles extending from the handle portion, wherein the plurality of bristles comprises a set of primary bristles and a plurality of protuberances, wherein proximal ends of at least one of the primary bristles and the plurality of protuberances are provided proximal from the handle portion and are provided in a concave arrangement. The case is operable to actuate between an open configuration and a closed configuration, wherein the case is operable to receive the therapeutic massage brush when the case is in the open configuration, and wherein the case is operable to house the therapeutic massage brush when the case is in the closed configuration.

The therapeutic massage system of the second aspect may include, optionally, wherein the case includes a plurality of projections operable to receive and align the therapeutic massage brush within the case when the case is in the closed configuration.

The therapeutic massage system of the second aspect may include one or more of the previous embodiments and, optionally, wherein the case includes a hinge, wherein the case transitions between the closed configuration and the open configuration about an axis through the hinge.

A third aspect of the present disclosure is directed to a method of forming a therapeutic massage brush. The method may include, but is not limited to, providing a plurality of bristles, wherein the plurality of bristles comprises a set of primary bristles and a plurality of protuberances. The method may include, but is not limited to, providing a handle portion. The method may include, but is not limited to, coupling the plurality of bristles to the handle portion, wherein proximal ends of at least one of the primary bristles and the plurality of protuberances are provided proximal from the handle portion and are provided in a concave arrangement when the substrate is coupled to the handle portion.

The method of the third aspect may include, optionally, wherein the plurality of bristles comprise a second set of bristles grouped together, and wherein each protuberance of the plurality of protuberances is at a proximal end of a particular grouping of bristles of the second set of bristles.

The method of the third aspect may include one or more of the previous embodiments and, optionally, wherein the plurality of bristles is coupled to a substrate, wherein the substrate includes a plurality of apertures, wherein each grouping of bristles of the second set of bristles is extended through a particular aperture of the plurality of apertures, and wherein the substrate is coupled to the handle portion.

The method of the third aspect may include one or more of the previous embodiments and, optionally, wherein the first set of bristles are coupled to a front surface of the substrate, and wherein each grouping of bristles of the second set of bristles is extended through a particular aperture of the plurality of apertures through a rear surface of the substrate prior to the rear surface of the substrate being coupled to the handle portion.

The method of the third aspect may include one or more of the previous embodiments and, optionally, wherein the substrate is coupled to the handle portion via an adhesive positioned between the substrate and the handle portion.

The method of the third aspect may include one or more of the previous embodiments and, optionally, wherein the handle portion comprises an upper surface, wherein the plurality of bristles is coupled to and extend from the upper surface, wherein a portion of the upper surface is visible after the plurality of bristles is coupled to the upper surface, and wherein the plurality of bristles is surrounded by a portion of the upper surface after the plurality of bristles are coupled to the upper surface.

A fourth aspect of the present disclosure is directed to a method of therapeutic massage. The method includes, but is not limited to, providing a therapeutic massage brush, the brush comprising: a handle portion operable to grasped by a user; a plurality of bristles extending from the handle portion, wherein the plurality of bristles comprises a set of primary bristles and a plurality of protuberances; and wherein proximal ends of at least one of the primary bristles and the plurality of protuberances are provided proximal from the handle portion and are provided in a concave arrangement. The method includes, but is not limited to, applying a force to a patient's body part, wherein the body part corresponds to or is proximate to a portion of the patient's lymphatic system and wherein the force is operable to cause or enhance a flow of lymphatic fluid within the patient.

The above-described embodiments, objectives, and configurations are neither complete nor exhaustive. As will be appreciated, other embodiments of the invention are possible using, alone or in combination, one or more of the features set forth above or described in detail below.

It shall be understood that the term “means” as used herein shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

FIG. 1A is a front elevation view of a therapeutic device according to one embodiment of the present disclosure.

FIG. 1B is a front elevation view of a therapeutic device according to one embodiment of the present disclosure.

FIG. 2 is a top plan view of the therapeutic device of the embodiment of FIG. 1A.

FIG. 3 is a bottom plan view of the therapeutic device of the embodiment of FIG. 1A.

FIG. 4A is a top plan view of the therapeutic device of the embodiment of FIG. 1A.

FIG. 4B is a front elevation view of the therapeutic device according to the embodiment of FIG. 4A.

FIG. 5A is a front elevation view of a therapeutic device according to one embodiment of the present disclosure.

FIG. 5B is a front elevation view of a therapeutic device according to one embodiment of the present disclosure.

FIG. 6 is a top plan view of the therapeutic device of the embodiment of FIG. 5A.

FIG. 7 is a bottom plan view of the therapeutic device of the embodiment of FIG. 5A.

FIG. 8A is a top plan view of the therapeutic device of the embodiment of FIG. 5A.

FIG. 8B is a front elevation view of the therapeutic device according to the embodiment of FIG. 8A.

FIG. 9A is a front elevation view of a therapeutic device according to an embodiment of the present disclosure.

FIG. 9B is a front elevation view of a therapeutic device according to an embodiment of the present disclosure.

FIG. 10A is a perspective view of a case for a therapeutic device according to one embodiment of the present disclosure, where the case is in an open configuration.

FIG. 10B is a perspective view of the case according to the embodiment of FIG. 10A, where the case is in a closed configuration.

FIG. 10C is a perspective view of a case and a therapeutic device according to an embodiment of the present disclosure, where the case is in an open configuration.

FIG. 10D is a perspective view of the case and the therapeutic device according to the embodiment of FIG. 10C, where the case is in a closed configuration.

FIG. 11 is an illustration of portions of a therapeutic device and a method of forming the same according to an embodiment of the present disclosure.

Similar components and/or features may have the same reference label. Further, various components of the same type may be distinguished by following the reference label by a letter that distinguishes among the similar components. If only the first reference label is used, the description is applicable to any one of the similar components having the same first reference label irrespective of the second reference label.

### DETAILED DESCRIPTION

Embodiments of the present disclosure contemplate and provide for methods and systems for massage and treatments (for example) wherein the tissue is manipulated and massaged via a brush with bristles. Specific bristle patterns and arrangements are provided to increase the accuracy, effectiveness, and comfort of treatments including, but not limited to, manual lymphatic drainage or MLD. Specific handle sizes and bristle counts are provided to additionally increase the accuracy, effectiveness, and comfort of treatments including, but not limited to, MLD.

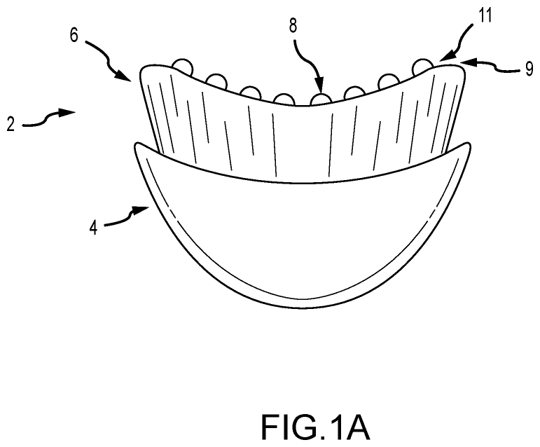

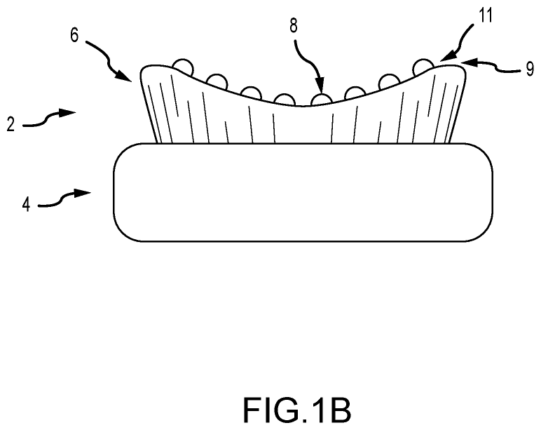

FIGS. 1A and 1B each illustrate a front elevation view of a therapeutic device 2 according to an embodiment of the present disclosure. The device 2 is operable for use such as massages to effect MLD. For purposes of the present disclosure, “device”, “therapeutic device,” “MLD device,” “MLD brush,” “brush,” “massage brush,” “massage device,” “therapeutic massage brush,” “therapeutic massage device,” and variants thereof should be understood as being equivalent and interchangeable.

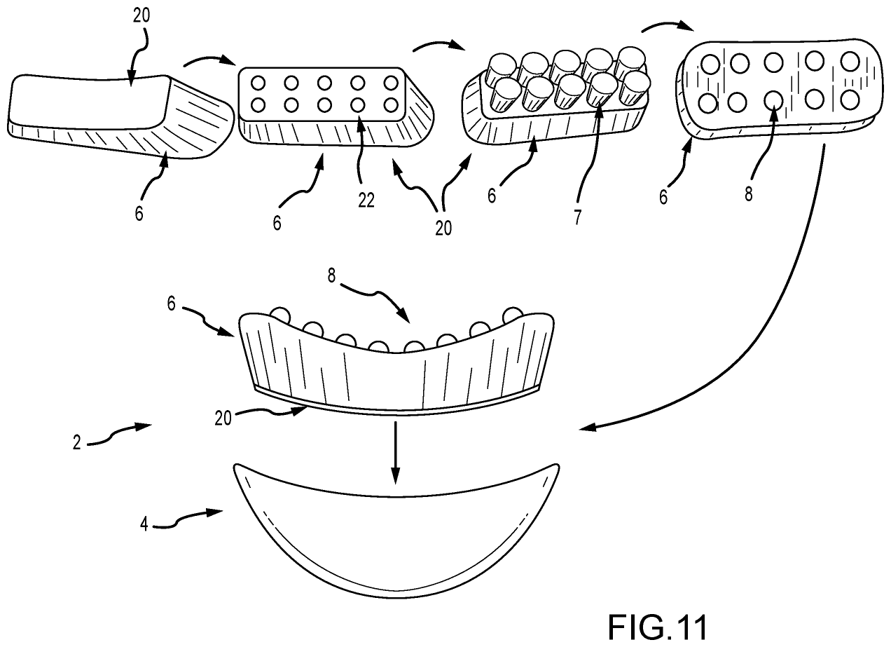

A handle portion 4 is provided with a plurality of bristles 6 extending from a contoured upper surface 5 (or proximal surface). Protuberances 8 are further provided that are on (and/or a part of) plurality of secondary bristles 7 (e.g., as illustrated in FIG. 11). It is noted that “protuberances” and “protrusions” may be considered equivalent, for purposes of the present disclosure.

Additionally, the bristles 6 comprise a concave profile as shown in FIG. 1A that forms a concave line 9 at the proximal end of the bristles 6 (e.g., farthest from the handle 4), such that the bristles 6 conform to and contour a person's anatomy. It is noted herein that the bristles 6 may be contoured to smooth the transition (e.g., round, or the like) between the concave line 9 and the long sidewalls of the bristles 6, or may be an abrupt change or step with substantially no transition, without departing from the scope of the present disclosure. In addition, it is noted that a single plurality of bristles 6 may be shaped and/or trimmed to form the protuberances 8 in addition to the concave line 9, such that only the primary bristles 6 are used and the secondary bristles 7 are not necessary, without departing from the scope of the present disclosure.

The bristles 6 and/or the bristles 7 of various embodiments of the present disclosure comprise a combination of parameters including quality, hardness, density, length, shape, pattern, and texture that increase the effectiveness of MLD. The plurality of bristles 6 comprise a set of bristles fabricated with a first set of parameters. Where installed, the secondary plurality of bristles 7 comprise a second set of bristles fabricated with a second set of parameters. The bristles 6 and the bristles 7 may include the same set of parameters, or may have one or more parameters that are different, depending on the requirements by the user for the therapeutic benefits of MLD.

The protuberances 8 provide an overall texture that provides a precise grip to enable lymphatic pull on tissue and mimic and increase the natural transit stretch of the lymphatic system or vessels. As will be recognized, the length of the bristles 8 directly impacts the bending point of the bristles and effects the overall feel, pressure application, and impact of the device on the tissue(s). Additionally, the contoured configuration of the bristle arrangement improves the ease of use and improved connection with the skin. The concave arrangement is provided to contour to the face, neck and body of a patient or recipient and align with the location of the lymph nodes and lymphatic pathways, resulting in increased mobility of fluid(s) and improved MLD.

In various embodiments, the protuberances 8 are a specific shape or represent a particular volume that increases the precise grip enabling lymphatic pull, in addition to the concave shape of the bristles 6. For example, the protuberances 8 may be dome-shaped or hemispherical, triangular prism-shaped, rectangular prism-shaped, or have a shape or volume that corresponds to any known three-dimensional (3D) polygon known in the art.

In some embodiments, the protuberances 8 may transition to a second shape or volume at a transition region 11. For example, the protuberances 8 may be a dome shape at a proximal end (e.g., farthest from the handle 4) that transitions at the transition region 11 to a cylindrical volume or rectangular prism volume. For instance, such as where the protuberances are formed from the bristles 6, the bristles 6 may be compiled in a cylindrical shape or volume, which is shaped or trimmed to a dome shape or volume at a proximal end to form the transition region 11 between the dome shape or volume and the cylindrical shape or volume, where the dome shape is positioned above the concave line 9 of the surrounding bristles 6. It is noted, however, that the transition region 11 may be above the concave line 9, at the concave line 9, or below/beneath the concave line 9 of the bristles 6, without departing from the scope of the present disclosure.

It is noted that the primary bristles 6 and/or the secondary bristles 7 with the protuberances 8 may be the same length or may be different lengths along the width of the brush 2, without departing from the scope of the present disclosure.

In various embodiments as illustrated in FIG. 1A, the handle 4 comprises an ergonomic shape to conform to the hand of a user and enable proper splaying of the bristles to contour to the skin and produce the correct transit stretch. For example, the ergonomic shape may be a convex shape, which is contemplated as comprising various materials and no limitation with respect to handle material is provided herewith. For example, the handle 4 is contemplated as comprising wood, plastic, metal, and various combinations thereof. In addition, ridges, gripping elements (e.g., rubber features) are contemplated as being provided on the handle 4. The size of the handle 4 is contemplated as being provided in various sizes to accommodate various hand sizes and is workable for all hand sizes, and specifically helpful for people with autoimmune or inflammatory conditions (e.g., arthritis). Devices of the present disclosure are well suited for both self-application wherein a user performs MLD on oneself and for administered MLD wherein a caregiver, masseuse, or other person performs MLD on a patient or recipient.

As illustrated in FIG. 1B, however, the handle 4 may be a shape like a rectangular prism or block, and/or have an upper surface 5 that is substantially flat, without departing from the scope of the present disclosure. For example, a block with a substantially flat upper surface 5 may be easier and cheaper to manufacture, especially where the bristles 6 and/or the protuberances 8 may be trimmed into a shape able to provide the therapeutic benefits as described throughout the present disclosure.

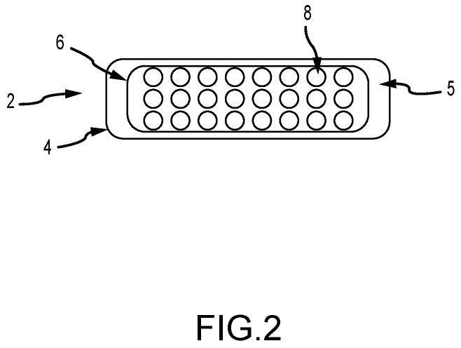

FIG. 2 is a top plan view of the brush 2 as shown in FIG. 1A or 1B. A plurality of primary bristles 6 extend from the handle 4. A plurality of protuberances 8 are provided that extend from and beyond the primary bristles 6. In some embodiments, the protuberances 8 are formed as part of secondary bristles 7 of the same material as the primary bristles 6 but extend beyond the primary bristles 6 and are shaped or formed as convex protuberances. In the embodiment shown in FIG. 2, the protuberances 8 are provided in a grid wherein eight protuberances 8 are provided across the width of the brush 2 and three protuberances 8 are provided across the depth of the brush 2.

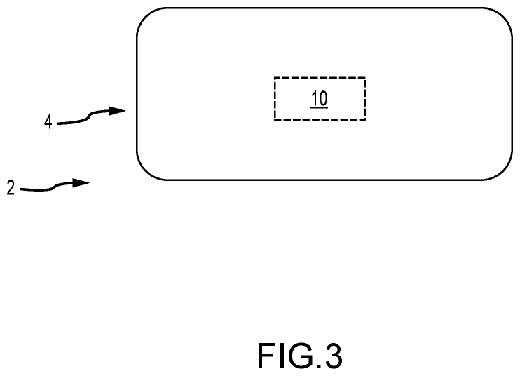

FIG. 3 is a bottom plan view of the brush 2 according to the embodiment of FIGS. 1A or 1B wherein the handle 4 is shown. The bottom of the handle 4 is contemplated as comprising a logo or indicia 10.

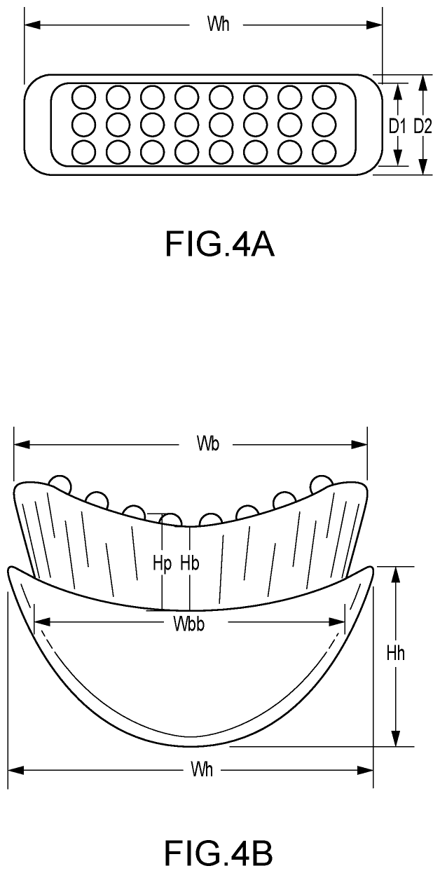

FIGS. 4A and 4B illustrate an example embodiment of the therapeutic device 2 of FIGS. 1A-3. In particular, FIGS. 4A-4B are top plan and front elevation views of a device 2 according to an embodiment of the present disclosure with various features as shown and described with respect to FIGS. 1A-3. In one embodiment, the therapeutic device 2 in FIGS. 1A-4B represents a facial brush.

As shown, the device comprises an overall width handle width Wh. For example, the handle 4 may have an overall handle width Wh of approximately 3.15 inches (80 millimeters (mm)) in width. It should be recognized, however, that no limitation with respect to particular dimensions is provided herewith. For example, the width Wh may comprise a width of between approximately 0.394 inches (10 mm) and 19.69 inches (500 mm). In certain preferred embodiments, however, it is contemplated that the width of the brush Wh is sized to fit comfortably within the hand of a user and therefore comprises a width of between approximately 2.36 inches (60 mm) and 3.94 inches (100 mm) and preferably of about 2.95 inches (75 mm) to 3.35 inches (85 mm).

The device comprises an overall depth D2 corresponding to the depth of the handle 4. For example, the handle 4 may have an overall depth D2 of approximately 0.866 inches (22.0 mm). It should be recognized, however, that no limitation with respect to particular dimensions is provided herewith. For example, the depth D2 may comprise a depth of between approximately 0.394 inches (10 mm) and 1.97 inches (50 mm). In certain preferred embodiments, however, it is contemplated that the depth of the brush D2 is sized to fit comfortably within the hand of a user.

Optionally, the handle 4 may include rounded corners on an upper surface 5 (or proximal surface) that traces a pre-determined radius between sidewalls (e.g., along the width) and endwalls (e.g., along the depth) of the handle 4.

The handle 4 includes an overall handle height Hh that is between approximately 0.394 inches (10 mm) and 3.94 inches (100 mm). It is noted that the handle 4 may be contoured to conform to the same or different arcs when viewed from a front or rear elevation view along the upper surface 5 or proximal surface of the handle 4 versus a lower surface or distal surface of the handle 4 including, but not limited to, a convex feature at its lowermost portion and a concave feature at its uppermost portion. For example, the handle 4 has a convex arc that has a longer sagitta than the concave arc, where the convex arc and the concave arc have the same endpoints at the endwalls. It is noted that the convex arc and/or the concave arc may trace or be a portion of an ellipse or oval (e.g., with different major, minor foci lengths) or a circle (e.g., with the same major, minor foci length). In one non-limiting example, the convex arc may trace or be a portion of an ellipse or oval, and the concave arc may trace or be a portion of a circle.

In one non-limiting example where the arcs are different, the height of the handle 4 differs at the endwalls of the handle 4 versus at a central plane through the sidewalls of the handle 4, with transition heights therebetween. For example, the height of the handle 4 at the central plane is less than the height of the handle 4 at the sidewalls, which is (in one non-limiting example) approximately 1.57 inches (40 mm).

Due to the convex arc shape of the handle 4, it is noted that the handle 4 may be contoured such that the transition between the sidewalls and endwalls is smooth or rounded, and without sharp or pointed corners therebetween.

The brush 2 has a bristle width Wbb and a bristle depth D1. In some embodiments, the bristle width Wbb is contemplated as being between approximately 0.787 inches (20 mm) and 3.94 inches (100 mm), and the bristle depth D1 is contemplated as being between approximately 0.59 inches (15.0 mm) and 0.98 inches (25.0 mm). In certain embodiments, the primary bristles 6 may be within an area on the handle 4 that is approximately 2.66 inches (67.6 mm) in width Wbb and approximately 0.748 inches (19 mm) in depth D1 at a distal end of the primary bristles 6 (e.g., at the upper surface 5 of the handle). Optionally, the primary bristles 6 may include rounded corners that trace a pre-determined radius. For example, the pre-determined radius may be contoured to conform to the radius of the corners of the upper surface 5 of the handle 4, and/or may be different than the radius of the corners of the upper surface 5 of the handle 4. In one non-limiting example, the primary bristles 6 may be centered within an upper surface 5 of the handle 4 such that the primary bristles 6 are offset by approximately 0.059 inches (1.5 mm) from each sidewall of the handle 4 and approximately 0.244 inches (6.2 mm) from each endwall of the handle 4, such that the upper surface 5 of the handle 4 is visible around the primary bristles 6 (e.g., which viewed from above).

In some examples, the primary bristles 6 may spread outward along the width of the brush 2 from a central plane defined through the sidewalls of the handle 4 (e.g., are flared outward), such that the proximal end of the primary bristles 6 have a maximum bristle width Wb. For example, the maximum bristle width Wb may be between approximately 1.97 inches (50 mm) and 5.91 inches (150 mm). In certain embodiments, the maximum bristle width Wb may be approximately 3.039 inches (77.2 mm). It is noted, however, that the primary bristles 6 may be the same width at the distal and proximal ends, such that Wbb approximately equals Wb, without departing from the scope of the present disclosure.

The protuberances 8 may range between approximately 0.020 inches (0.5 mm) and 0.0394 inches (10 mm) in diameter, height, and/or spacing therebetween. In certain embodiments, the protuberances 8 may be approximately 0.157 inches (4 mm) tall, and/or may be domes that are approximately 0.197 inches (5 mm) in diameter. Where there are eight protuberances 8 along the width of the device 2, the first protuberance 8 may be approximately 0.165 inches (4.2 mm) from a first end of the primary bristles 6, adjacent protuberances 8 may each be spaced substantially equally or evenly at approximately 0.110 inches (2.8 mm) apart, and the last (or eighth) protuberance 8 may be approximately 0.165 inches (4.2 mm) from a second opposite end of the primary bristles 6. Spacing between the protuberances is contemplated as being between approximately 0.020 inches (0.5 mm) and 0.394 inches (10 mm). In certain embodiments, where there are three protuberances 8 along the depth of the device 2, the first protuberance 8 may be approximately 0.028 inches (0.7 mm) from a first side of the primary bristles 6, adjacent protuberances 8 may each be spaced substantially equally or evenly at approximately 0.039 inches (1.0 mm) apart, and the last (or third) protuberance 8 may be approximately 0.028 inches (0.7 mm) from a second opposite side of the primary bristles 6.

The primary bristles 6 have a bristle height Hb, and the secondary bristles 7 in combination with the protuberances 8 have a bristle height Hp. It is contemplated that the height Hb may range between approximately 0.197 inches (5 mm) and 1.96 inches (50 mm), and the height Hp may range between approximately 0.39 inches (10 mm) and 2.17 inches (55 mm). In certain embodiments, such as at a center point (e.g., at the central plane) of the handle 4, the primary bristles 6 may have a height Hb of approximately 0.866 inches (22 mm) tall and the secondary bristles 7 with the protuberances 8 may have a height Hp of approximately 1.024 inches (26 mm) tall. At the point outermost along the width from the central plane of the handle 4, the primary bristles 6 may be approximately 1.023 inches (26 mm) tall and the secondary bristles 7 with the protuberances 8 may be approximately 1.102 inches (30 mm) tall. It is noted that the secondary bristles 7 and the protuberances 8 may collectively be referred to as the protuberances 8, without departing from the scope of the present disclosure.

Where there is a logo or indicia 10, the logo or indicia 10 may fit within an area that is approximately 0.984 inches (25.0 mm) in width and approximately 0.512 inches (13.0 mm) in depth.

Although the above embodiment includes aspects such as being “spaced substantially evenly or equally” or “centered” or “same or similar shape or volume” it should be understood that the therapeutic device 2 in the present embodiment may be differently-configured such that the asymmetries and/or different dimensions are introduced into the build of the therapeutic device 2, dependent on the user's preferences, without departing from the scope of the present disclosure.

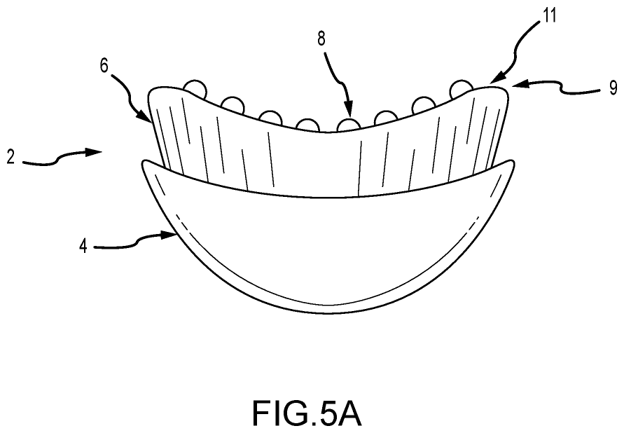

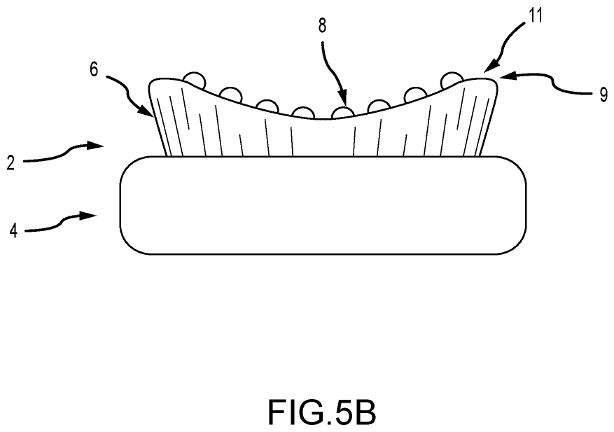

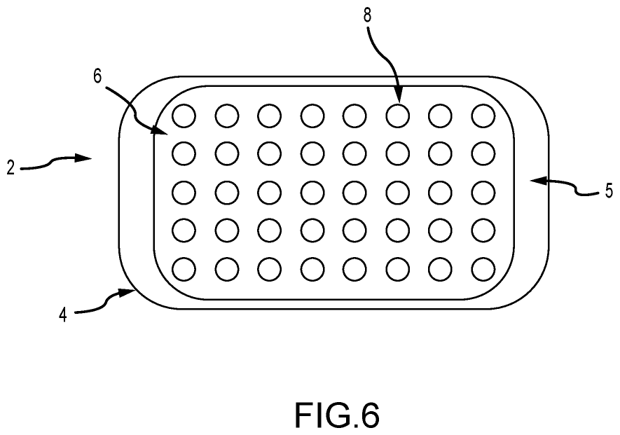

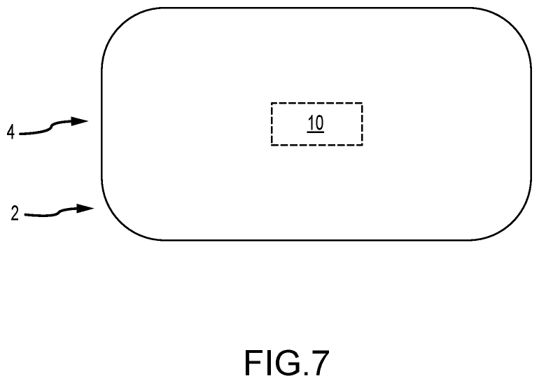

FIGS. 5A-8B depict a MLD device 2 according to another embodiment of the present disclosure. It should be understood that embodiments directed to the therapeutic device 2 of FIGS. 1A-4B should be understood as reading on the MLD device 2 of FIGS. 5A-8B, and vice versa, unless otherwise noted throughout the present disclosure.

As shown, the device 2 comprises substantially the same construction as the embodiment of FIGS. 1A-4B. However, the device 2 of FIGS. 5A-8B comprises a larger device with an array of protuberances 8 provided in a 5×8 configuration, wherein eight protuberances 8 are provided across the width of the brush 2 and five protuberances 8 are provided across the depth of the brush 2. Devices of the present disclosure are contemplated as being provided, sized, and/or scaled to accommodate various different patients of different sizes and/or are operable for use on different portions and regions of the lymphatic system. As noted, embodiments of the present disclosure are not limited to specific uses. While certain embodiments are contemplated as being well suited for use with lymphangion and lymph nodes in the neck and face region, embodiments of the present disclosure not so limited. Methods, devices, and systems of the present disclosure are contemplated for use with various regions of the body and/or as devices and methods useful in non-MLD applications.

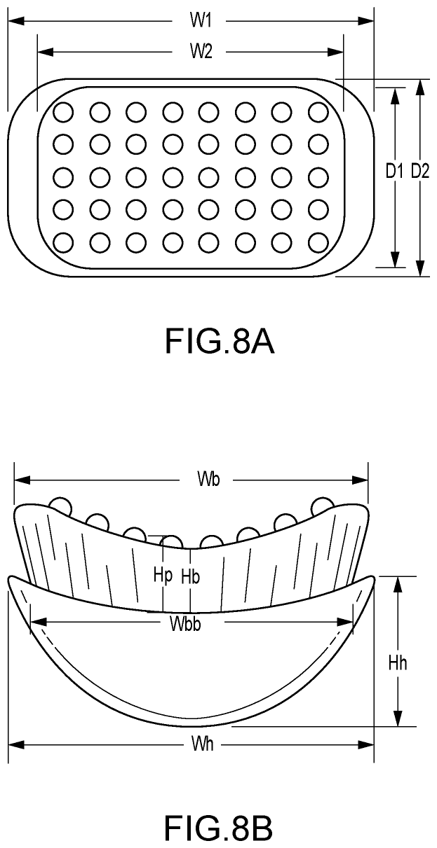

FIGS. 8A and 8B illustrate an example embodiment of the MLD device 2 of FIGS. 5A-7. In particular, FIGS. 8A and 8B are top plan and front elevation views of a device according to an embodiment of the present disclosure with various features as shown and described with respect to FIG. 5A-7. In one embodiment, the therapeutic device 2 in FIGS. 5A-8B represents a body brush.

As shown, the device comprises an overall width handle width Wh. For example, the handle 4 may have an overall handle width Wh of approximately 3.76 inches (95.4 millimeters (mm)) in width. It should be recognized, however, that no limitation with respect to particular dimensions is provided herewith. For example, the width Wh may comprise a width of between approximately 0.394 inches (10 mm) and 19.7 inches (500 mm). In certain preferred embodiments, however, it is contemplated that the width of the brush Wh is sized to fit comfortably within the hand of a user and therefore comprises a width of between approximately 2.36 inches (60 mm) and 5.91 inches (150 mm) and preferably of about 2.95 inches (75 mm) to 4.33 inches (110 mm).

The device comprises an overall depth D2 corresponding to the depth of the handle 4. For example, the handle 4 may have an overall depth D2 of approximately 2.04 inches (51.8 mm). It should be recognized, however, that no limitation with respect to particular dimensions is provided herewith. For example, the depth D2 comprises a dimension of between approximately 0.394 inches (10.0 mm) and 3.94 inches (100.0 mm). In certain preferred embodiments, however, it is contemplated that the depth of the brush D2 is sized to fit comfortably within the hand of a user.

Optionally, the handle 4 may include rounded corners on an upper surface 5 (or proximal surface) that traces a pre-determined radius between sidewalls (e.g., along the width) and endwalls (e.g., along the depth) of the handle 4.

The handle 4 includes an overall handle height Hh that is between approximately 0.394 inches (10 mm) and 3.94 inches (100 mm). It is noted that the handle 4 may be contoured to conform to the same or different arcs along the upper surface 5 or proximal surface of the handle 4 versus a lower surface or distal surface of the handle 4 including, but not limited to, a convex feature at its lowermost portion and a concave feature at its uppermost portion. For example, the handle 4 has a convex arc that has a longer sagitta than the concave arc, where the convex arc and the concave arc have the same endpoints at the endwalls. It is noted that the convex arc and/or the concave arc may trace or be a portion of an ellipse or oval (e.g., with different major, minor foci lengths) or a circle (e.g., with the same major, minor foci length). In one non-limiting example, the convex arc may trace or be a portion of an ellipse or oval, and the concave arc may trace or be a portion of a circle.

In one non-limiting example where the arcs are different, the height of the handle 4 differs at the endwalls of the handle 4 versus at a central plane through the sidewalls of the handle 4, with transition heights therebetween. For example, the height of the handle 4 at the central plane is less than the height of the handle 4 at the sidewalls, which is approximately 1.57 inches (40 mm).

Due to the convex arc shape of the handle 4, it is noted that the handle 4 may be contoured such that the transition between the sidewalls and endwalls is smooth or rounded, and without sharp or pointed corners therebetween.

The brush 2 as a bristle width W2 and a bristle depth D1. In some embodiments, the bristle width W2 is contemplated as being between approximately 1.96 inches (50 mm) and 3.94 inches (100 mm), and the bristle depth D1 is contemplated as being between approximately 0.787 inches (20.0 mm) and 2.95 inches (75.0 mm). In certain embodiments, the primary bristles 6 may be within an area on the handle 4 that is approximately 3.17 inches (80.4 mm) in width W2 and approximately 1.92 inches (48.8 mm) in depth D1 at a distal end of the primary bristles 6 (e.g., at the upper surface 5 of the handle). Optionally, the primary bristles 6 may include rounded corners that trace a pre-determined radius. For example, the pre-determined radius may be contoured to conform to the radius of the corners of the upper surface 5 of the handle 4, and/or may be different than the radius of the corners of the upper surface 5 of the handle 4. In one non-limiting example, the primary bristles 6 may be centered within an upper surface 5 of the handle 4 such that the primary bristles 6 are offset by approximately 0.059 inches (1.5 mm) from each sidewall of the handle 4 and approximately 0.295 inches (7.5 mm) from each endwall of the handle 4, such that the upper surface 5 of the handle 4 is visible around the primary bristles 6 (e.g., which viewed from above).

In some examples, the primary bristles 6 may spread outward along the width of the brush 2 from a central plane defined through the sidewalls of the handle 4, such that the proximal end of the primary bristles 6 have a maximum bristle width Wb. For example, the bristle width Wb may be between approximately 1.97 inches (50 mm) and 5.91 inches (150 mm). In certain embodiments, the maximum bristle width Wb may be approximately 3.62 inches (92.0 mm). It is noted, however, that the primary bristles 6 may be the same width at the distal and proximal ends, such that W2 approximately equals Wb, without departing from the scope of the present disclosure. The protuberances 8 may range between approximately 0.020 inches (0.5 mm) and 0.0394 inches (10 mm) in diameter, height, and/or spacing therebetween. In certain embodiments, the protuberances 8 may be approximately 0.157 inches (4 mm) tall, and/or may be domes that are approximately 0.197 inches (5 mm) in diameter. Where there are eight protuberances 8 along the width of the device 2, the first protuberance 8 may be approximately 0.177 inches (4.5 mm) from a first end of the primary bristles 6, adjacent protuberances 8 may each be spaced substantially equally or evenly at approximately 0.177 inches (4.5 mm) apart, and the last (or eighth) protuberance 8 may be approximately 0.177 inches (4.5 mm) from a second opposite end of the primary bristles 6. Spacing between the protuberances is contemplated as being between approximately 0.020 inches (0.5 mm) and 0.394 inches (10 mm). In certain embodiments, where there are five protuberances 8 along the depth of the device 2, the first protuberance 8 may be approximately 0.189 inches (4.8 mm) from a first side of the primary bristles 6, adjacent protuberances 8 may each be spaced substantially equally or evenly at approximately 0.138 inches (3.5 mm) apart, and the last (or fifth) protuberance 8 may be approximately 0.189 inches (4.8 mm) from a second opposite side of the primary bristles 6.

The primary bristles 6 have a bristle height Hb, and the secondary bristles 7 in combination with the protuberances 8 have a bristle height Hp. It is contemplated that the height Hb may range between approximately 0.197 inches (5 mm) and 1.96 inches (50 mm), and the height Hp may range between approximately 0.39 inches (10 mm) and 2.17 inches (55 mm). In certain embodiments, such as at a center point (e.g., at the central plane) of the handle 4, the primary bristles 6 may be approximately 0.866 inches (22 mm) tall and the secondary bristles 7 with the protuberances 8 may be approximately 1.024 inches (26 mm) tall. At the point outermost along the width from the central plane of the handle 4, the primary bristles 6 may be approximately 1.024 inches (26 mm) tall and the secondary bristles 7 with the protuberances 8 may be approximately 1.18 inches (30 mm) tall.

Where there is a logo or indicia 10, the logo or indicia 10 may fit within an area that is approximately 0.984 inches (25.0 mm) in width and approximately 0.512 inches (13.0 mm) in depth.

Although the above embodiment includes aspects such as being “spaced substantially evenly or equally” or “centered” or “same or similar shape or volume” it should be understood that the MLD device 2 in the present embodiment may be differently-configured such that the asymmetries and/or different dimensions are introduced into the build of the MLD device 2, dependent on the user's preferences, without departing from the scope of the present disclosure.

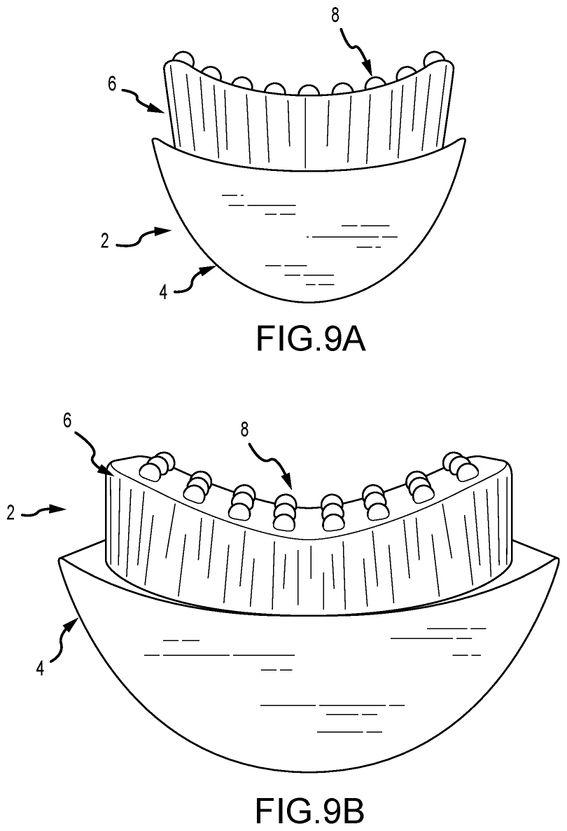

FIGS. 9A-9B illustrate brushes 2 of different embodiments. In particular, FIG. 9A illustrates a brush 2 of a first size, and FIG. 9B illustrates a brush 2 of a second, different size. Brushes 2 of the present disclosure are provided with a handle 4 that is convex at its bottom and concave at an upper end proximal to where the bristles are secured to the brush. Bristles are contemplated as being secured to the handle by various means including, for example, adhesive(s). It is noted that FIGS. 9A and 9B may be understood as illustrating either of the example embodiment configurations of FIGS. 1A-4B and 5A-8B, as described throughout the present disclosure.

As illustrated in FIGS. 1A-4B, 5A-8B, and 9A-9B, the handles 4 may be fabricated from a particular material and/or include a pattern that emulates or mimics a particular material. For example, the handle 4 may be fabricated from natural material, such as woodgrain or rock vein. By way of another example, the pattern or texture may be a synthetic pattern that emulates or mimics a particular material, such as wood veneer or a sticker with a woodgrain or rock vein design or pattern. It is noted that the handle 4 may be smooth, or may be textured to provide additional tactile feedback to a user. It is noted, however, that the handles 4 may be unpatterned or of a solid-color and/or texture, without departing from the scope of the present disclosure.

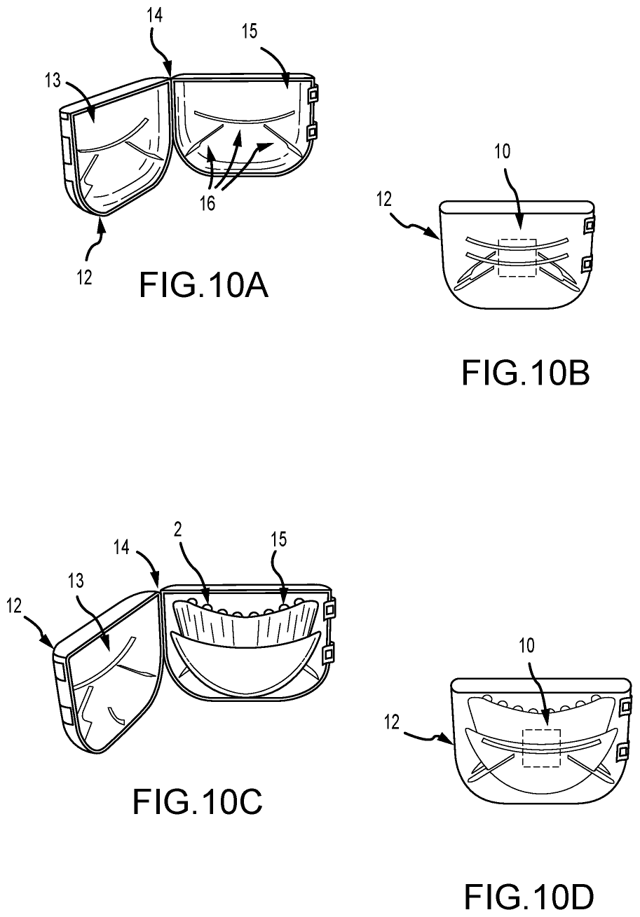

FIGS. 10A-10D illustrate a brush 2 and a case 12 according to an embodiment of the present disclosure. It is noted herein that the brush 2 and the case 12 may be components of a therapeutic massage system, for purposes of the present disclosure.

As shown, a case 12 is contemplated for use with and containment of a brush 2 according to various embodiments of the present disclosure (e.g., as illustrated in FIGS. 1A-4B, 5A-8B, 9A-8B, and as completed in FIG. 11). The case 12 is contemplated as a carrying case to secure a brush and maintain its cleanliness during transit and other situations. It is noted that FIG. 10A illustrates an open configuration of the case 12 without the brush 2, and FIG. 10B illustrates a closed configuration of the case 12 without the brush 2. In addition, it is noted that FIG. 10C illustrates an open configuration of the case 12 with the brush 2, and FIG. 10D illustrates a closed configuration of the case 12 with the brush 2. The case 12 is operable to actuate between an open configuration and a closed configuration, and is operable to receive the therapeutic massage brush 2 when the case 12 is in the open configuration, and wherein the case 12 is operable to house the therapeutic massage brush 2 when the case 12 is in the closed configuration.

The case 12 comprises a device with a hinge 14 or other interlocking assembly. In certain embodiments, the case 12 is able to transition between the closed configuration and the open configuration about an axis through the hinge 14. The hinge 14 may be permanently or semi-permanently assembled, such that a first portion 13 of the case 12 is always attached to a second portion 15 of the case 12. Alternatively, the hinge 14 may include components that are able to disengage, such that the first portion 13 of the case 12 may be removed from the second portion of the case 12.

In some embodiments, the case 12 comprises projections 16 for receiving and aligning a brush 2 when the case 12 is in the closed configuration. For example, the projections 16 may be contoured to receive portions of the handle 4 and/or the bristles 6, to hold the brush 2 in place and reduce or inhibit movement (e.g., rattling, and the like) within the case 12 when in the closed configuration. It is noted, however, that one or more of the projections 16 may be shaped independently of the brush 2, without departing from the scope of the present disclosure.

In some embodiments, the case 12 comprises a molded plastic device. The case 12 is contemplated being clear or translucent to reveal the brush and is further contemplated as comprising a molded plastic feature.

In additional embodiments, the case 12 may include a logo or indicia 10. For example, the logo or indicia 10 may be formed within the case 12 (e.g., within the first portion 13 of the case 12). By way of another example, the logo or indicia 10 may be adhered to an exterior or interior surface of the case 12 (e.g., is a sticker, label, or the like).

FIG. 11 illustrates various components of a therapeutic device and method of forming the same. While a general order for the steps of the method or process is shown in FIG. 11, the method or process can include more or fewer steps or can arrange the order of the steps differently (including simultaneously, substantially simultaneously, or sequentially) than those shown in FIG. 11. It is noted that the method or process shall be explained with reference to the components, devices, assemblies, environments, etc. described in conjunction with FIGS. 1-11. For example, it is noted that the embodiments directed to the devices 2 as illustrated in FIGS. 1A-4B, 5A-8B, 9A-9B, and 10A-10D should be understood as reading on the embodiments described with respect to FIG. 11, and vice versa, without departing from the scope of the present disclosure.

In a step, a plurality of primary bristles 6 are provided. As shown, the plurality of primary bristles 6 protrude from and/or are secured to a substrate 20. The substrate 20 preferably comprises a flexible member that can be conformed to and secured to the handle (not shown in FIG. 11). In the depicted embodiment, a bristle arrangement of the device 2 comprises bristles of different length and arrangements. It is noted that a distal or rear surface of the substrate 20 is illustrated in this step, with the plurality of primary bristles 6 being positioned underneath the substrate 20 and coupled to a front or proximal surface of the substrate 20.

In a step, a plurality of apertures 22 are formed in the substrate 20 to form the arrangement of the depicted embodiment. For example, the apertures 22 may be drilled into the distal or rear surface of the substrate 20. It is noted, however, that the substrate 20 may be pre-formed with the holes 22, without departing from the scope of the present disclosure.

In a step, secondary bristles 7 of different length, density, and/or hardness are provided. The secondary bristles 7 may be inserted into the substrate 20 to extend through the apertures 22. It is noted herein that the second bristles 7 may be bundled in a volume with a cross-sectional shape that conforms to the corresponding hole 22, or may be bundled in a volume with a cross-sectional shape that does not conform to the corresponding hole 22, without departing from the scope of the present disclosure. In addition, it is noted that the secondary bristles 7 may be a different color to make them distinguishable from the primary bristles 6 once extended through the apertures 22.

In a step, the substrate is turned over such that proximal ends of the bristles are provided. In some embodiments, the primary bristles 6 and/or the secondary bristles 7 may then be trimmed and shaped, such that the bristles 6 are a first, shorter height and the bristles 7 are a second, taller height to create the protrusions 8 as desired. It is noted, however, that the bristles 6 and/or the bristles 7 may be pre-cut to specific desired heights, without departing from the scope of the present disclosure. In addition, it is noted that the bristles 7 may extend through the substrate 20 to the desired height to form the protrusions 8, such that trimming and/or shaping of the bristles 6 and/or the bristles 7 is not necessary, without departing from the scope of the present disclosure.

In a step, the substrate 20 and with bristles 6 and bristles 7 with protrusions 8 are then coupled (e.g., secured via adhesion or via an interlocking assembly between the handle 4 and the substrate 20) to the handle 4 to form the complete device 2. For example, an adhesive may be positioned between the substrate 20 and the handle portion 4. For instance, the adhesive may be applied to the substrate 20 (or is part of the substrate 20 to be activated with heat, or the like) or is applied to the handle portion 4. In addition, the adhesive may be a film positioned between the substrate 20 and the handle portion 4.

In a step (not shown), a case is provided for the brush 2. The case 12 may be designed to conform to the brush 2. It is noted, however, that the case may be independently designed of the brush 2, without departing from the scope of the present disclosure.

It is noted herein that one or more of the above steps may be understood as falling within a step of “providing a therapeutic massage brush” of a method or process of therapeutic massage, without departing from the scope of the present disclosure. In addition, it is noted herein that the of “providing a therapeutic massage brush” of the method or process of therapeutic massage may include providing portions of or an entirely pre-manufactured brush 2, such that one or more of the above steps are not necessary, without departing from the scope of the present disclosure.

In a step (not shown), the method or process of providing a therapeutic massage with the brush 2 includes applying a force to a body part of a patient or user. In embodiments, the body part corresponds to or is proximal to a portion of the lymphatic system of the patient or user. For example, the force is operable to cause or enhance a flow of lymphatic fluid within the patient or user.

Reference to an element by the indefinite article “a” or “an” does not exclude the possibility that more than one element is present, unless the context clearly requires that there be one and only one element. The indefinite article “a” or “an” thus usually means “at least one.”

The phrases “at least one,” “one or more,” and “and/or,” as used herein, are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

As used herein, “about,” “approximately ,” and “substantially” means within a statistically meaningful range of a value or values such as a stated concentration, length, molecular weight, pH, sequence identity, time frame, temperature, or volume. Such a value or range can be within an order of magnitude, typically within 20%, more typically within 10%, and even more typically within 5% of a given value or range. The allowable variation encompassed by “about,” “approximately,” and “substantially” will depend upon the particular system under study, and can be readily appreciated by one of skill in the art.

The examples set forth above are provided to give those of ordinary skill in the art a complete disclosure and description of how to make and use the embodiments of the methods for prediction of the selected modifications that may be made to a biomolecule of interest, and are not intended to limit the scope of what the inventors regard as the scope of the disclosure. Modifications of the above-described modes for carrying out the disclosure may be used by persons of skill in the art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A therapeutic massage brush comprising:
a handle portion operable to grasped by a user; and
a plurality of bristles extending from the handle portion, wherein the plurality of bristles comprises a set of primary bristles and a plurality of protuberances,
wherein proximal ends of at least one of the primary bristles and the plurality of protuberances are provided proximal from the handle portion and are provided in a concave arrangement.

2. The therapeutic massage brush of claim 1, wherein the plurality of bristles comprise a second set of bristles grouped together, and wherein each protuberance of the plurality of protuberances is at a proximal end of a particular grouping of bristles of the second set of bristles.

3. The therapeutic massage brush of claim 2, wherein the plurality of bristles is coupled to a substrate that is couplable to a handle portion, wherein the substrate includes a plurality of apertures, and wherein each grouping of bristles of the second set of bristles is extended through a particular aperture of the plurality of apertures.

4. The therapeutic massage brush of claim 3, wherein the first set of bristles are coupled to a front surface of the substrate, and wherein each grouping of bristles of the second set of bristles is extended through a particular aperture of the plurality of apertures through a rear surface of the substrate prior to the rear surface of the substrate being coupled to the handle portion.

5. The therapeutic massage brush of claim 2, wherein the first set of bristles of the plurality of bristles have a first hardness and a first density, and wherein the second set of bristles of the plurality of bristles have a second, different hardness and a second, different density.

6. The therapeutic massage brush of claim 1, wherein the handle portion includes a convex distal end and a concave proximal end.

7. The therapeutic massage brush of claim 6, wherein the convex distal end of the handle portion is contoured to conform to a first arc and the concave proximal end of the handle portion is contoured to conform to a second different arc.

8. The therapeutic massage brush of claim 7, wherein the first arc is a portion of an ellipse and the second arc is a portion of a circle.

9. The therapeutic massage brush of claim 1, wherein the handle portion comprises an upper surface, and wherein the plurality of bristles is coupled to and extend from the upper surface.

10. The therapeutic massage brush of claim 9, wherein a portion of the upper surface is visible after the plurality of bristles is coupled to the upper surface.

11. The therapeutic massage brush of claim 10, wherein the plurality of bristles is surrounded by a portion of the upper surface after the plurality of bristles are coupled to the upper surface.

12. A therapeutic massage system, comprising:
a therapeutic massage brush comprising:
a handle portion operable to grasped by a user; and
a plurality of bristles extending from the handle portion, wherein the plurality of bristles comprises a set of primary bristles and a plurality of protuberances,
wherein proximal ends of at least one of the primary bristles and the plurality of protuberances are provided proximal from the handle portion and are provided in a concave arrangement; and
a case operable to actuate between an open configuration and a closed configuration, wherein the case is operable to receive the therapeutic massage brush when the case is in the open configuration, and wherein the case is operable to house the therapeutic massage brush when the case is in the closed configuration.

13. The therapeutic massage system of claim 12, wherein the case includes a plurality of projections operable to receive and align the therapeutic massage brush within the case when the case is in the closed configuration.

14. The therapeutic massage system of claim 12, wherein the case includes a hinge, wherein the case transitions between the closed configuration and the open configuration about an axis through the hinge.

15. A method of forming a therapeutic massage brush, comprising:
providing a plurality of bristles, wherein the plurality of bristles comprises a set of primary bristles and a plurality of protuberances;
providing a handle portion; and
coupling the plurality of bristles to the handle portion, wherein proximal ends of at least one of the primary bristles and the plurality of protuberances are provided proximal from the handle portion and are provided in a concave arrangement when the substrate is coupled to the handle portion.

16. The method of claim 15, wherein the plurality of bristles comprise a second set of bristles grouped together, and wherein each protuberance of the plurality of protuberances is at a proximal end of a particular grouping of bristles of the second set of bristles.

17. The method of claim 16, wherein the plurality of bristles is coupled to a substrate, wherein the substrate includes a plurality of apertures, wherein each grouping of bristles of the second set of bristles is extended through a particular aperture of the plurality of apertures, and wherein the substrate is coupled to the handle portion.

18. The method of claim 17, wherein the first set of bristles are coupled to a front surface of the substrate, and wherein each grouping of bristles of the second set of bristles is extended through a particular aperture of the plurality of apertures through a rear surface of the substrate prior to the rear surface of the substrate being coupled to the handle portion.

19. The method of claim 17, wherein the substrate is coupled to the handle portion via an adhesive positioned between the substrate and the handle portion.

20. The method of claim 15, wherein the handle portion comprises an upper surface, wherein the plurality of bristles is coupled to and extend from the upper surface, wherein a portion of the upper surface is visible after the plurality of bristles is coupled to the upper surface, and wherein the plurality of bristles is surrounded by a portion of the upper surface after the plurality of bristles are coupled to the upper surface.
